(19) United States
(12) Patent Application Publication
(10) Pub. No.: US 2007/0211977 A1
(43) Pub. Date: Sep. 13, 2007

(54) Trunnion bearing and method of assembly

(75) Inventors: John Cowles, Somers, CT (US); Alex Habibvand, Orange, CA (US); Nick D'Amore, Burlington, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/714,945

(22) Filed: Mar. 6, 2007

Related U.S. Application Data
(60) Provisional application No. 60/782,310, filed on Mar. 13, 2006.

(51) Int. Cl. F16C 33/60

(52) U.S. Cl. 384/504

(57) ABSTRACT

A trunnion bearing has a generally cylindrical trunnion member that defines two inner ring raceways. A mounting pin is disposed within the trunnion member and an outer ring encircles the inner ring raceways. The outer ring defines raceways that are aligned with respective inner ring raceways. There is a row of balls between each inner ring raceway and a respective outer ring raceway. A bearing is assembled by placing a mounting pin within a trunnion member. An outer ring having raceways on its interior surface is placed eccentrically around the trunnion member. Each outer ring raceway is aligned with an inner ring raceway. The eccentricity creates an insertion opening for balls. Balls are inserted between the inner ring raceways and their respective outer ring raceways via the insertion opening. The balls are distributed around the trunnion member, and the outer ring moves into concentric relation with the trunnion member.

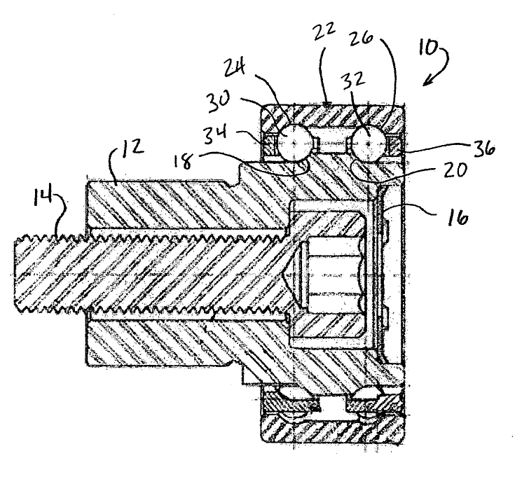

### CROSS-REFERENCE TO RELATED APPLICATION

This application claims the benefit of U.S. provisional application No. 60/782,310, filed Mar. 13, 2006, which is hereby incorporated herein by reference, in its entirety.

### BACKGROUND

Trunnion bearings are known for supporting loads at points offset from the attachment points of the bearings. Prior art trunnion bearings are comprised of an excessive number of discrete parts that make the assembly of the bearing difficult. In addition, the large number of parts makes it necessary to manufacture the bearings to high standards in order to provide acceptable performance.

It is the general object of this invention to provide a trunnion bearing and method of assembly that improves upon, or overcomes the problems and drawbacks of prior art trunnion bearings.

### SUMMARY OF THE INVENTION

The present invention resides in one aspect in a trunnion bearing that comprises a generally cylindrical trunnion member having an exterior surface and a central axis. The trunnion member defines two inner ring raceways in the exterior surface, the inner ring raceways being axially distanced from each other. There is a mounting pin disposed within the trunnion member and an outer ring encircling the inner ring raceways. The outer ring has an interior surface and defines two outer ring raceways on the interior surface. Each of the two outer ring raceways are aligned with a respective inner ring raceway; and there are two rows of balls, one row between each one of the inner ring raceways and a respective outer ring raceway.

The present invention resides in another aspect in a method of assembling a trunnion bearing, the method including providing a generally cylindrical trunnion member having an exterior surface and a central axis, the trunnion member defining two inner ring raceways in the exterior surface, the inner ring raceways being axially distanced from each other. A mounting pin is placed within the trunnion member. An outer ring is placed eccentrically about the inner ring raceways, the outer ring having an interior surface and defining two outer ring raceways on the interior surface. Each of the two outer ring raceways are axially aligned with a respective inner ring raceway, the eccentric placement creating an insertion opening for balls. A row of balls is inserted between each one of the inner ring raceways and a respective outer ring raceway via the insertion opening. The balls are distributed around the trunnion member, and the outer ring is moved into concentric relation with the trunnion member.

### BRIEF DESCRIPTION OF THE DRAWING

The FIGURE is a schematic cross-sectional view of one embodiment of a trunnion bearing according to the present invention.

### DETAILED DESCRIPTION OF THE INVENTION

One embodiment of a trunnion bearing according to this invention is shown in the accompanying FIGURE. Trunnion bearing 10 comprises a generally cylindrical trunnion member 12 having an exterior surface and a central axis that extends through an internal passage that extends axially through the trunnion member 12. A mounting pin 14 comprising a socket head cap screw is disposed within the trunnion member 12. The interior passage of the trunnion member 12 comprises a stepped surface to provide a shoulder to engage a head portion of the screw forming the mounting pin therein. The mounting pin 14 is configured so that when the screw head engages the shoulder in the trunnion member 12, a portion of the mounting pin 14 protrudes from the trunnion member 12 to be secured to a supporting structure on which the trunnion bearing 10 is to be mounted. A retaining ring 16 is mounted in the interior passage of the trunnion member 12 after the mounting pin 14 is inserted therein. The retaining ring 16 is sized and configured to prevent the head portion of the mounting pin 14 from exiting from the interior passage of trunnion member 12, and thus prevents the mounting pin 14 from becoming separated from the trunnion member 12 before the trunnion bearing 10 is mounted to the supporting structure. The retaining ring 16 is also configured to permit access to the head portion of the screw so that a driving tool can be employed to secure the mounting pin 14 to the support structure.

The trunnion member 12 has a raceway portion where two inner ring raceways 18, 20 are formed on the exterior surface of the trunnion member. The inner ring raceways 18, 20 are axially distanced from each other. There is an outer ring 22 encircling the inner ring raceways 18, 20 on the trunnion member 12. The trunnion member 12 is configured so that a portion thereof protrudes from the outer ring 22.

The outer ring 22 has an interior surface that defines two outer ring raceways 24, 26 thereon. Each of the two outer ring raceways 24, 26 are substantially aligned with a respective one of the inner ring raceways 18, 20. Optionally, the outer ring raceways 24, 26 are offset from the inner ring raceways 18, 20 as known in the art so that trunnion bearing 10 has thrust bearing attributes, as desired.

There are two pluralities of balls 30, 32 in rows between, and in simultaneous contact with, each of the inner ring raceways 18, 20 and their respective one of the outer ring raceways 24, 26. A spacing cage 34 maintains the balls 30 in a substantially even distribution around trunnion member 12. Likewise, spacing cage 36 maintains balls 32 in a substantially even distribution around trunnion member 12.

In illustrative embodiments, the trunnion member 12, balls 30 and 32, the mounting pin 14 and the retaining ring 16 may all be made from steel alloys. The cages 34 and 36 may be formed from a polymeric material or a composite material, e.g., glass-fiber filled nylon. Optionally, the minimum outer diameter of the inner ring raceways 18, 20 and the diameter of the outer ring raceways 24, 26 and the balls 30 and 32 may be sized and configured to produce a preload on the bearing. The magnitude of the internal preload can be controlled by the size of the balls and the axial spacing between the ball races. The difference in axial spacing between the ball raceways on the trunnion member 12 and the outer ring 20 is nominally set slightly less (e.g., about 0.0002 inch) than the nominal axial play the bearing would have if not preloaded. Manufacturing tolerances are accounted for by providing balls with a fine ball size spread, e.g., about 50 millionths of an inch. The preload of each bearing can be adjusted by measuring the actual inner and outer race diameters, and picking the appropriate ball size at assembly.

According to a method for assembling such a bearing, the outer ring 22 is placed about the raceway portion of the trunnion member 12. The outer ring 22 is placed eccentrically about the inner ring raceways, thus creating an insertion opening for balls on one side of the trunnion member 12. Balls 30, 32 are inserted between the raceways on the trunnion member 12 and the outer ring 22 while the outer ring 22 is in the eccentric relationship with the trunnion member 12. Then, the balls 30, 32 are distributed more evenly around the trunnion member 12, which causes the outer ring 22 to move into concentric relation with the trunnion member 12. The cages are slipped into the gap between the trunnion member 12 and the outer ring 22 and are snapped in place to engage the balls. The mounting pin 14 is inserted into the interior of the trunnion member 12 and the retaining ring 16 is then secured to the trunnion member 12.

In a particular trunnion bearing as described herein, the bearing is a cartridge-type, double row angular contact ball bearing utilizing a Conrad fill. The bearing is constituted using a single outer ring and an inner ring that is integral with the trunnion member. The overall accuracy of such a bearing manufactured at an ABEC-5 level is as good as a comparative trunnion bearing that is manufactured at an ABEC-7 level and that comprises two outer rings and an inner ring that is a distinct structure from the trunnion member. The improved overall accuracy is a result of reducing the number of parts in the bearing. The ABEC scale was developed by the Annular Bearing Engineering Committee or Council (ABEC) of the American Bearing Manufacturers Association (ABMA) for rating the manufacturing tolerances of precision bearings with a number from 1 to 9, with the higher number assigned to bearings manufactured against a higher standard of precision, i.e., to more stringent tolerances. The following Table 1 summarizes the ABEC scale criteria, and Table 2 indicates a general correspondence of ABEC scales to other known standards.

TABLE 1

| | | | ABEC- | ABEC- | ABEC- |
|---|---|---|---|---|---|
| All tolerances are in .0001 inches | ABEC-1 | ABEC-3 | 5p | 7p | 9p |
| INNER RING (Bore Diameter <0.7087 | | | | | |
| inches) | | | | | |
| Bore Tolerance | +0/−3 | +0/−2 | +0/−2 | +0/−2 | +0/−2 |
| Radial Runout (Bore 0–0.3937″) | 3 | 2 | 1.5 | 1 | 0.5 |
| Radial Runout (Bore 0.3937–0.7087″) | 4 | 3 | 1.5 | 1 | 0.5 |
| Width Tolerance | +0/−50 | +0/−50 | +0/−10 | +0/−10 | +0/−10 |
| Width Variation | — | — | 2 | 1 | 0.5 |
| Reference Runout with Bore (max) | — | — | 3 | 1 | 0.5 |
| Groove Runout with Reference Side (max) | — | — | 3 | 1 | 0.5 |
| Bore 2 Point Out of Round (max) | — | — | 1 | 1 | 0.5 |
| Bore Taper (max) | — | — | 1 | 1 | 0.5 |
| OUTER RING (OUTER Diameter <0.875 | | | | | |
| inches) | | | | | |
| Outer Diameter Tolerance | +0/−3 | +0/−3 | +0/−2 | +0/−2 | +0/−1 |
| Radial Runout (max) | 6 | 4 | 2 | 1.5 | 0.5* |
| Width Tolerance | +0/−50 | +0/−50 | +0/−10 | +0/−10 | +0/−10 |
| Width Variation | — | — | 2 | 1 | 0.5 |
| Flange Width Tolerance Limits | — | +0/−20 | +0/−20 | +0/−20 | — |
| Flange Diameter Tolerance Limits | — | +50/−20 | +0/−10 | +0/−10 | — |
| Groove Runout with Reference Side (max) | — | — | 3 | 2 | 0.5* |
| Outside Cylindrical Surface | | | | | |
| Runout with Reference Side (max) | — | — | 3 | 1.5 | 0.5 |

*For ABEC 9 Bearings with Outer Diameters from 0.787 to 0.875
O.D tolerance = +0/−1.5
Radial Runout = 1
Groove Runout with Reference Side = 1

TABLE 2

| ABEC SYSTEM | ISO SYSTEM | DIN SYSTEM |
|---|---|---|
| ABEC 1 | Normal | P0 |
| ABEC 3 | Class 6 | P6 |
| ABEC 5 | Class 5 | P5 |
| ABEC 7 | Class 4 | P4 |
| ABEC 9 | Class 2 | P2 |

### EXAMPLE

In a particular trunnion bearing, the trunnion member 12, balls 30 and 32 and the mounting pin 14 are all made from 440C stainless steel. The cages 34 and 36 are formed from glass-fiber filled nylon 6/6, and the retaining ring 16 is made from PH15-7 Mo alloy steel. The minimum outer diameter of the inner ring raceways 18, 20 is about 0.47 inch. There are eleven balls 30 and eleven balls 32, all sized at 5/64 inch diameter. The balls and raceways have a finish of 4 Ra (microinches) max. The outer ring 22 is sized to produce a preload on the bearing of about 5 pounds. When preloaded, has a breakaway friction torque of not more than about 0.75 inch-ounce (in.-oz.). The bearing is manufactured to comply with ABEC-5 and is rated for dynamic radial load of 66 pounds and thrust loads as high as 132 pounds.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A trunnion bearing comprising:
a generally cylindrical trunnion member having an exterior surface and a central axis, the trunnion member defining two inner ring raceways in the exterior surface, the inner ring raceways being axially distanced from each other;
a mounting pin disposed within the trunnion member;
an outer ring encircling the inner ring raceways, the outer ring having an interior surface and defining two outer ring raceways on the interior surface, each of the two outer ring raceways being aligned with a respective inner ring raceway; and
two rows of balls, one row between each one of the inner ring raceways and a respective outer ring raceway.

2. The bearing of claim 1 further comprising a spacing cage between the trunnion member and the outer ring to maintain a separation between the balls.

3. The bearing of claim 1 wherein the balls are sized to preload the outer ring.

4. The bearing of claim 1 wherein the balls are sized to preload the outer ring and wherein the difference in axial spacing between the ball raceways on the trunnion member and on the outer ring is less than the axial play the bearing would have if not preloaded.

5. A method for assembling a trunnion bearing, the method comprising:
providing a generally cylindrical trunnion member having an exterior surface and a central axis, the trunnion member defining two inner ring raceways in the exterior surface, the inner ring raceways being axially distanced from each other;
placing a mounting pin within the trunnion member;
placing an outer ring eccentrically about the inner ring raceways, the outer ring having an interior surface and defining two outer ring raceways on the interior surface, each of the two outer ring raceways being axially aligned with a respective inner ring raceway, the eccentric placement creating an insertion opening for balls;
inserting a row of balls between each one of the inner ring raceways and a respective outer ring raceway via the insertion opening; and
distributing the balls around the trunnion member and moving the outer ring into concentric relation with the trunnion member.

6. The method of claim 5, further comprising inserting a ball cage between each inner ring raceway and the respective outer ring raceway.

7. The method of claim 5, further comprising preloading the outer ring.
